(19) United States
(12) Patent Application Publication
(10) Pub. No.: US 2025/0198840 A1
(43) Pub. Date: Jun. 19, 2025

(54) HIGH FREQUENCY MODULATION CHOPPER

(71) Applicant: NOVA LTD., Rehovot (IL)

(72) Inventors: Asaf ILOVITSH, Petah Tikva (IL); Yonatan OREN, Kiryat Ono (IL)

(73) Assignee: NOVA LTD., Rehovot (IL)

(21) Appl. No.: 18/848,905

(22) PCT Filed: Mar. 21, 2023
(86) PCT No.: PCT/IB2023/052780

§ 371 Date: Sep. 19, 2024

Related U.S. Application Data
(60) Provisional application No. 63/269,636, filed on Mar. 21, 2022.

(51) Int. Cl. G01J 3/02; G01J 3/42

(52) U.S. Cl. CPC G01J 3/0232; G01J 3/42

(57) ABSTRACT

A system for evaluating a sample, the system includes (i) a chopper that includes (i.1) a disc that is made of a transparent material that bears an inner opaque pattern and outer opaque pattern, the outer opaque pattern surrounds the inner opaque pattern, and (i.2) a rotating unit that is configured to rotate the disc during a modulation period, (ii) first optics, (iii) second optics, (iv) a control unit that is configured to detect a second modulated beam from the second optics, and control the rotating unit based on at least one parameter of the second modulated beam.

### BACKGROUND OF THE INVENTION

Light modulation is extensively used in various metrology methods, such as fast imaging, fast spectroscopy and pump-probe schemes. A common way to implement such modulation is through a mechanical chopper—a rotating disc comprised of regions where light can pass and opaque blades where it is blocked (see chopper 10 with blades 11 of FIG. 1).

Using high rotation frequencies and narrow blades, modulations in the range of several kHz can be reached. However, it is extremely challenging to reach >10 kHz modulations in this approach. This shortcoming significantly limits chopper-based metrology implementations.

Main approaches allowing higher modulation frequencies are:
a. Mechanical chopper at ultra-high rotation frequencies: these approaches are mechanically and electronically challenging, and commonly involve severe acoustic and vibrational implications. Using a chopper disc with more blades requires individual blades to be extremely narrow, reducing their mechanical strength. As stated, solution of this type allowing >10 kHz modulation frequencies are not commercially available today.
b. Direct-control over the light source, e.g. in direct-modulated lasers: of course, only applicable for light sources which can be thus modulated. Most importantly, such implementation is irrelevant when the modulation is to take place at any location in the optical path other than the source (e.g. at collection).
c. Using acousto-optic modulators: these devices allow extremely high modulation frequencies, but are only applicable for a narrow wavelengths range.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a prior art example of a chopper;

FIG. 2 illustrates an example of a disc that is made from transparent material; and

FIG. 3 illustrates an example of a chopper;

FIG. 4 illustrates an example of a system; and

FIG. 5 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

There may be provided a disc (that may be a solid disc) that is made from transparent material and also bears one or more patterns. The disc may be used for high frequency light chopping.

There may be provided a unit that may include (a) disc that is made from transparent material (for example—glass) and bears an outer opaque pattern and an inner opaque pattern, the outer opaque pattern surrounds the inner opaque pattern (b) control electronics, and (c) first and second optics.

The inner opaque pattern and/or the outer opaque pattern can be made from optically-opaque material (for example—metallic).

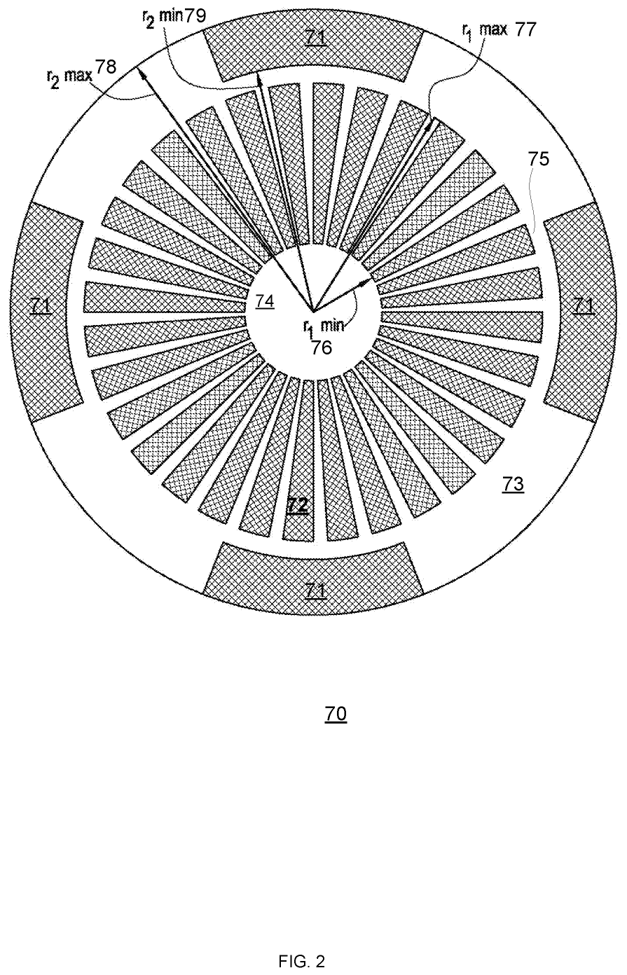

The outer opaque pattern surrounds the inner opaque pattern in the sense that (a) the inner opaque pattern spans over a first radial distance range that spans between a first minimal radial distance R1_min (denoted 76 in FIG. 2) and a first maximal radial distance R1_max (denoted 77 in FIG. 2), (b) the outer opaque pattern spans over a second radial distance range that spans between a second minimal radial distance R2_min (denoted 78 in FIG. 2) and a second maximal radial distance R2_max (denoted 79 in FIG. 2). R1_min does not exceed R2_min.

The inner opaque pattern may include a first array of first radial elements, while the outer opaque pattern may include a second array of second radial elements.

The number of first radial elements may exceed the number of second radial lines.

The radial difference between adjacent first radial elements may be smaller than the radial difference between adjacent second radial elements.

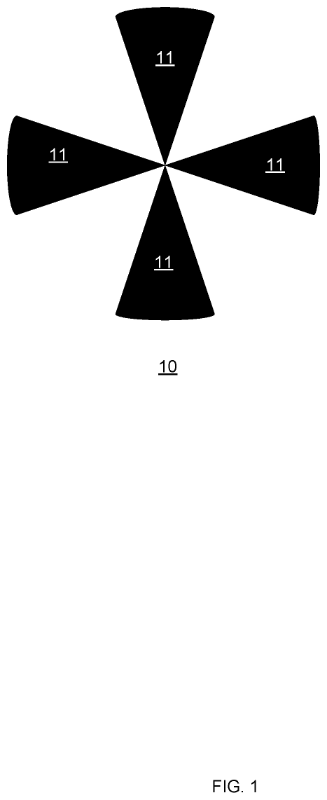

The inner opaque pattern is used for the high-frequency chopping of the first optical beam to provide a first modulated beam. Contrary to standard mechanical choppers, the inner opaque pattern may have no role in the mechanical integrity of the chopper—in contrary to mechanically spaced apart mechanical modulation elements as in FIG. 1. As a result, extremely fine and dense first radial elements can be used.

The outer opaque pattern is used to control and synchronize the chopper. A second beam is modulated by the outer opaque pattern to provide a second modulated beam that is sensed (by a second detector) and the frequency of rotation of the chopper is detected—and if needed—corrected to a desired frequency of rotation.

Especially—the detector is configured to detect the second modulated beam and sends detection signals indicative of the second modulated beam to control electronics that monitor the disc rotation (for example—determine the current rotation frequency of the disc) and may adjust the rotation speed (or frequency) of the disc to a desired speed or rotation frequency.

The detector and the control electronics may belong to a control unit.

The desired rotation speed (or frequency) may be determined in order to synchronize the modulation by the inner opaque pattern to other modulations—for example modulations of other beams, and/or to other modulated elements in a measurement apparatus.

The ratio between the number of first radial elements of the inner opaque pattern and the number of second radial elements of the outer opaque pattern dictates the ratio between the modulation frequency of the first beam and modulation frequency of the second beam. Higher ratios increase the difference between the modulation frequency of the first beam and the modulation frequency of the second beam—and allows to operate a relatively simple control loop for controlling the rotation of the chopper.

It should be noted that the outer opaque pattern and the inner opaque pattern are printed on the disc—and maintain their spatial relationship regardless of the rotation of the disc—which guarantees synchronization between the control loop and the modulation of the first beam.

The first optics are configured to direct a first beam onto the inner opaque pattern, during a modulation period, to provide a first modulated beam of a first modulation frequency.

The second optics are configured to direct a second beam onto the outer opaque pattern to provide a second modulated beam of a second modulation frequency that is lower than the first modulation frequency.

The first optics may be configured to (i) focus the first beam to the inner opaque pattern. A third optics may be configured to collimate the second modulated beam, allowing continued beam propagation of the second modulated beam.

The second optics may be configured to focus the second beam to the outer opaque pattern. A fourth optics may be configured to collimate the second modulated beam, allowing continued beam propagation of the second modulated beam.

The first and/or second optics may be of less significance if the disc is placed at a location in which the first beam and/or the second beam, respectively, are already focused by other means.

The suggested solution allows broadband optical modulation at frequencies reaching 100 kHz. Importantly, this is achieved with essentially no increased complexity to the involved control electronics, as synchronization is implemented at lower-frequency allowing the use of off-the-shelf control electronics.

There are various advantages for higher-frequency modulations, among which:
a. Reduced noise: a broad set of noise sources have typical frequency dependence of 1/f (f being the measurement frequency); increasing the modulation frequency can thus improve signal-to-noise ratio.
b. Access to high-frequency sample response: especially in fast imaging and pump-probe schemes, the ability to probe a sample at higher frequencies can allow sensitivity to otherwise-inaccessible properties. For example, in a pump-probe measurement, some physical effects have response times measured in micro-seconds. Probing these properties requires correspondingly high frequencies.

An example of a method and system for broadband photoreflectance spectroscopy that may include the chopper unit illustrated in the current application is illustrated in U.S. patent application Ser. No. 17/757,224 publication serial number 2023/0003637 which is incorporated herein by reference.

There may be provided a system for evaluating a sample, the system may include: (i) a chopper, wherein the chopper may include (i.1) a disc that may be made of a transparent material that bears an inner opaque pattern and outer opaque pattern, the outer opaque pattern surrounds the inner opaque pattern; and (i.2) a rotating unit that may be configured to rotate the solid disc during a modulation period; (ii) first optics that are configured to direct a first beam onto the inner opaque pattern, during the modulation period, to provide a first modulated beam of a first modulation frequency; (iii) second optics that are configured to direct a second beam onto the outer opaque pattern to provide a second modulated beam of a second modulation frequency that may be lower than the first modulation frequency; and (iv) a control unit that may be configured to detect the second modulated beam, and control the rotating unit based on at least one parameter of the second modulated beam.

The system may include third optics that may be configured to illuminate the sample with the first modulated beam, to direct radiation emitted from the sample due to the illumination, to a first sensing unit.

The system may include a first processing circuit that may be configured to evaluate the sample based on detection signals generated by the first sensing unit.

The third optics may be configured to illuminate the sample during a pump probe based evaluation of the sample.

The third optics may be configured to illuminate the sample during a spectroscopy based evaluation of the sample.

There may be a gap between the inner opaque pattern and the outer opaque pattern.

The inner opaque pattern may include a first array of first opaque elements that are evenly spaced apart from each other.

The outer opaque pattern may include a second array of second opaque elements that are evenly spaced apart from each other.

A number of the first opaque elements exceeds a number of the second opaque element.

The inner opaque pattern may include a first array of radial fins, the radial fins exhibit a first width, and a first angle may be formed between each pair of adjacent radial fins of the first array.

The outer opaque pattern may include a second array of radially symmetrical elements that exhibit a second width that exceeds the first width, wherein a second angle may be formed between centers of each pair of adjacent radially symmetrical elements, the second angle exceeds the first angle.

The radially symmetrical elements of the second array may be arc elements.

The first optics may include a collimator that may be configured to collimate the first modulated beam.

The first modulation frequency may exceeds 100,000 Hertz.

The second modulation frequency that may be lower by at least a factor of five than the first modulation frequency.

The fill factor of each one of the inner opaque pattern and the outer opaque pattern may be fifty percent.

The transparent material may be made of glass.

The at least one of the inner opaque pattern or the outer opaque pattern may be made of metal

FIG. 2 illustrates an example of a disc 70 that includes outer opaque pattern 71 that includes four second radial elements, inner opaque pattern 72 that includes thirty two first radial elements, and transparent body 73. The four second radial elements surround a transparent inner circle 74. There may be a gap 75 (such as an annular gap) between the outer opaque pattern and the inner opaque pattern.

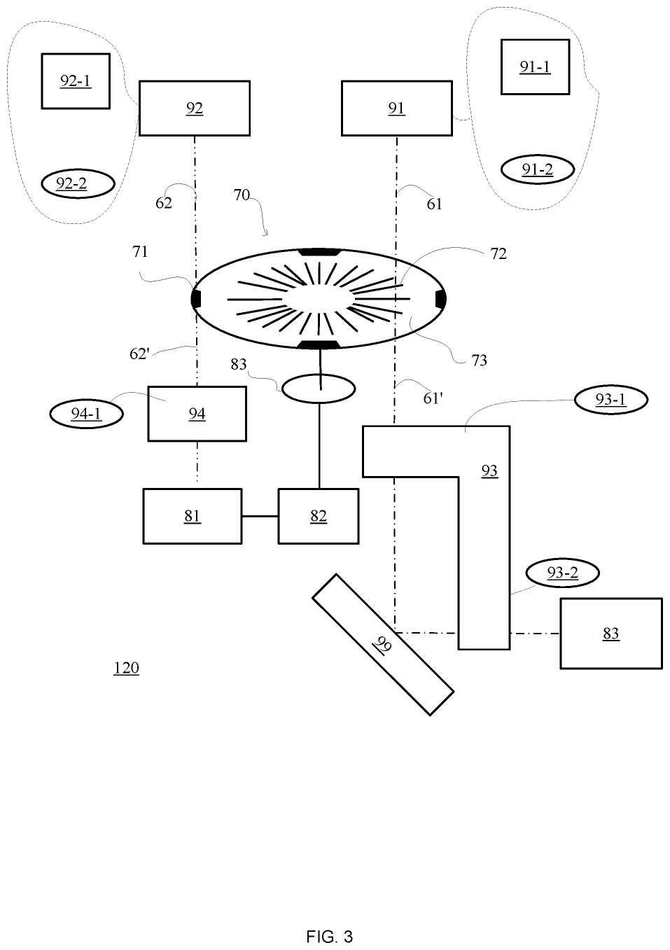

FIG. 3 illustrates an example of a chopper 120.

Chopper 120 includes:
a. Disc 70. Disc 70 may include an outer opaque pattern 71 that includes second radial elements, inner opaque pattern 72 that includes first radial elements, and transparent body 73
b. First optics 91 that may be configured to focus the first beam 61 to the inner opaque pattern.
c. Second optics that may be configured to focus the second beam 61 to the outer opaque pattern.
d. Third optics 93 that are configured to collimate the first modulated beam 61′ and direct the first modulated beam 61′ to a sample 99, and direct reflected radiation to a first detection unit 83.
e. Fourth optics 94 that are configured to collimate the second modulated beam 92′.
f. A control unit that may include (ii) detector 81 for detecting the second modulated beam and generating detection signals accordingly, and (ii) control electronics 82 that are configured to determine, based on the detection signals, the current rotation frequency (or speed) of the disc, and to adjust the rotation frequency (or speed) of the disc to a desired rotation frequency (or speed)—thereby controlling rotation unit 83.
g. Rotation unit 83 that is configured to rotate the disc under the control of the control electronics.

In FIG. 3:
a. The first optics 91 are illustrated as including a first beam source 91-1 followed by a first lens 91-2.
b. The second optics 92 are illustrated as including a second beam source 92-1 followed by a second lens 92-2.
c. The third optics 93 are illustrated as including a third lens 93-1 and an additional third-lens 93-2.
d. The fourth optics 94 are illustrated as including a fourth lens 94-1.

Any one of the first till fourth optics may include other and/or additional optical components.

In some cases the first modulated beam is not sensed, and the third optical may include less components—as illustrated in FIG. 3.

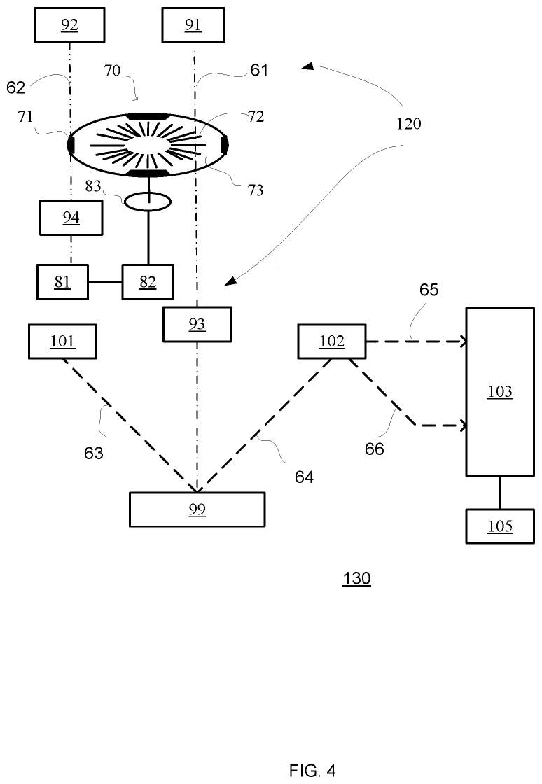

FIG. 4 illustrates sample 99 and a measurement apparatus 130 for photoreflectance (PR) spectroscopy.

Measurement apparatus 130 includes chopper of FIG. 3 (with a more compact third optics 93), as well as probe beam elements.

The chopper 120 is used to generate a pump beam that is a modulated pump beam. The modulated pump beam is an example of a first modulated beam.

The measurement apparatus also include other units such as: (i) probe source 101 for generating probe beam 63, (ii) deflector 102 that is configured to receive response radiation 64 reflected from sample 99 (following of the illumination of the sample with probe beam 63) to direct the response radiation (including pump-on beam and pump off beam denoted 65 and 55) to spectrometer 103, (iii) spectrometer 103 that is configured to sense the response radiation, (iv) processing unit 105) that is configured to process the sensed radiation.

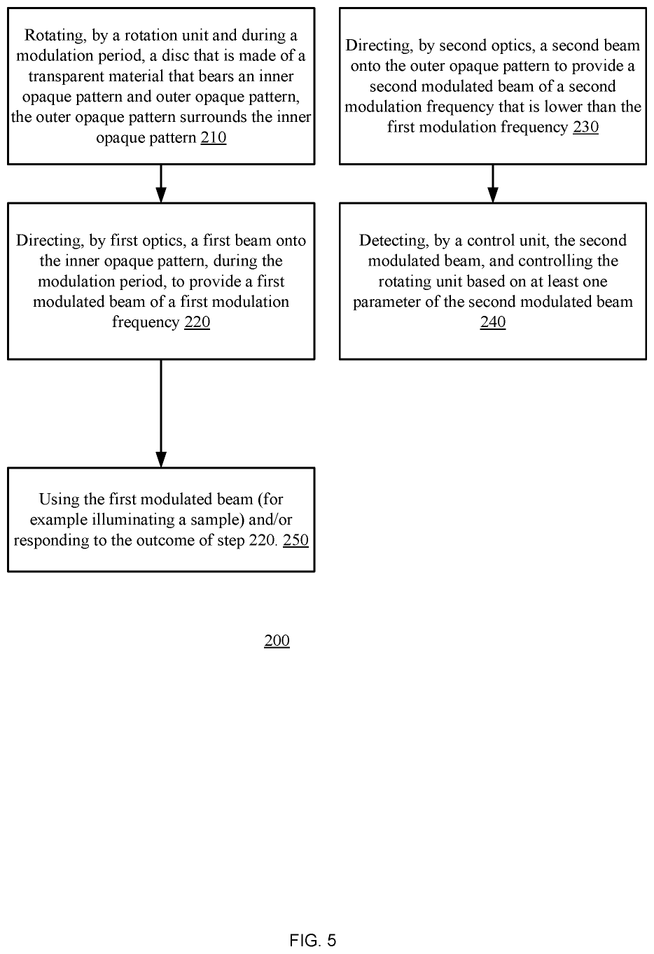

FIG. 5 illustrates an example of method 200 for high frequency modulation.

Method 200 may include step 210 of rotating, by a rotation unit and during a modulation period, a disc that is made of a transparent material that bears an inner opaque pattern and outer opaque pattern, the outer opaque pattern surrounds the inner opaque pattern.

A modulation period is a period during which light modulation is executed. A modulation period may be followed by or preceded by a non-modulation period in which no modulation is required. For example—when a pump beam should be modulated—then the modulation period occurs during the generation of the pump beam. If, for example, a measurement requires to illuminate a sample following the pump beam—and where the probe beam is not modulated—then the probe beam may illuminate the sample during a non-modulation period.

Step 210 may be followed by step 220 of directing, by first optics, a first beam onto the inner opaque pattern, during the modulation period, to provide a first modulated beam of a first modulation frequency.

Method 200 may also include step 230 of directing, by second optics, a second beam onto the outer opaque pattern to provide a second modulated beam of a second modulation frequency that is lower than the first modulation frequency.

Step 230 may be followed by step 240 of detecting, by a control unit, the second modulated beam, and controlling the rotating unit based on at least one parameter of the second modulated beam.

Step 220 may be followed by step 250 of using the first modulated beam (for example illuminating a sample) and/or responding to the outcome of step 220.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A system for evaluating a sample, the system comprising:
a chopper, wherein the chopper comprises:
a disc that is made of a transparent material that bears an inner opaque pattern and outer opaque pattern, the outer opaque pattern surrounds the inner opaque pattern; and
a rotating unit that is configured to rotate the disc during a modulation period;
first optics that are configured to direct a first beam onto the inner opaque pattern, during the modulation period, to provide a first modulated beam of a first modulation frequency;
second optics that are configured to direct a second beam onto the outer opaque pattern to provide a second modulated beam of a second modulation frequency that is lower than the first modulation frequency; and
a control unit that is configured to detect the second modulated beam, and control the rotating unit based on at least one parameter of the second modulated beam.

2. The system according to claim 1, comprising third optics that is configured to illuminate the sample with the first modulated beam, to direct radiation emitted from the sample due to the illumination, to a first sensing unit.

3. The system according to claim 2, comprising a first processing circuit that is configured to evaluate the sample based on detection signals generated by the first sensing unit.

4. The system according to claim 2, wherein the third optics is configured to illuminate the sample during a pump probe based evaluation of the sample.
The system according to claim 2, wherein the third optics is configured to illuminate the sample during a spectroscopy based evaluation of the sample.

5. The system according to claim 1, wherein there is a gap between the inner opaque pattern and the outer opaque pattern.

6. The system according to claim 1, wherein the inner opaque pattern comprises a first array of first opaque elements that are evenly spaced apart from each other;
wherein the outer opaque pattern comprises a second array of second opaque elements that are evenly spaced apart from each other; and
wherein a number of the first opaque elements exceeds a number of the second opaque element.

7. The system according to claim 1, wherein the inner opaque pattern comprises a first array of radial fins, the radial fins exhibit a first width, and a first angle is formed between each pair of adjacent radial fins of the first array.

8. The system according to claim 7, wherein the outer opaque pattern comprises a second array of radially symmetrical elements that exhibit a second width that exceeds the first width, wherein a second angle is formed between centers of each pair of adjacent radially symmetrical elements, the second angle exceeds the first angle.

9. The system according to claim 8, wherein the radially symmetrical elements of the second array are arc elements.

10. The system according to claim 1, wherein the first optics comprises a collimator that is configured to collimate the first modulated beam.

11. The system according to claim 1, wherein the first modulation frequency exceeds 100,000 Hertz.

12. The system according to claim 1, wherein the second modulation frequency that is lower by at least a factor of five than the first modulation frequency.

13. The system according to claim 1, wherein a fill factor of each one of the inner opaque pattern and the outer opaque pattern is fifty percent.

14. The system according to claim 1, wherein the transparent material is made of glass.

15. The system according to claim 1, wherein at least one of the inner opaque pattern or the outer opaque pattern is made of metal.

16. A method for high-frequency modulation, the method comprises:
rotating, by a rotation unit and during a modulation period, a disc that is made of a transparent material that bears an inner opaque pattern and outer opaque pattern, the outer opaque pattern surrounds the inner opaque pattern;
directing, by first optics, a first beam onto the inner opaque pattern, during the modulation period, to provide a first modulated beam of a first modulation frequency;
directing, by second optics, a second beam onto the outer opaque pattern to provide a second modulated beam of a second modulation frequency that is lower than the first modulation frequency; and
detecting, by a control unit, the second modulated beam, and controlling the rotating unit based on at least one parameter of the second modulated beam.
